(19) United States
(12) Patent Application Publication
(10) Pub. No.: US 2022/0287134 A1
(43) Pub. Date: Sep. 8, 2022

(54) Network Nodes and Methods in a Wireless Communication Network

(71) Applicant: Telefonaktiebolaget LM Ericsson (publ), Stockholm (SE)

(72) Inventors: Angelo Centonza, Granada (ES); Daniel Henriksson, Linköping (SE); Stefan Engström, Linköping (SE); Peter Werner, Linköping (SE)

(21) Appl. No.: 17/634,353

(22) PCT Filed: Jul. 2, 2020
(86) PCT No.: PCT/SE2020/050698

§ 371 Date: Feb. 10, 2022

Related U.S. Application Data
(60) Provisional application No. 62/887,752, filed on Aug. 16, 2019.

(51) Int. Cl. H04W 76/19; H04W 48/16

(52) U.S. Cl. CPC H04W 76/19; H04W 48/16

(57) ABSTRACT

The present disclosure relates to telecommunications. In one of its aspects, the disclosure concerns a method, performed by a first network node, for handling communication in a wireless communication system. The method comprises transmitting, to a second network node, a message related to a connection establishment between the first network node and the second network node, wherein the message comprises at least one of: a first indication indicating whether a list of served cells of the first network node comprised in the message is a partial list of cells; a second indication indicating a maximum number of cells in a list of served cells of the second network node that the first network node can receive; and a third indication indicating a reason for a failure of the connection establishment.

### TECHNICAL FIELD

The present disclosure generally relates to telecommunications and embodiments herein relate to a first and a second network node and methods performed therein. In particular, the various embodiments described in this disclosure relate to network nodes and methods for handling communication in a wireless communication network.

### BACKGROUND

In a typical wireless communication network, wireless devices, also known as wireless communication devices, mobile stations, stations (STA) and/or user equipment (UE), communicate via a Local Area Network (LAN) such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5th Generation (5G). A service area or cell area is a geographical area where radio coverage is provided by the radio network node. The radio network node communicates over an air interface operating on radio frequencies with the wireless device within range of the radio network node. The radio network node communicates to the wireless device in DownLink (DL) and from the wireless device in UpLink (UL).

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3rd Generation (3G) networks. In general, in E-UTRAN/LTE the functions of a 3G RNC are distributed between the radio network nodes, e.g. eNodeBs in LTE, and the CN. As such, the RAN of an EPS has an essentially “flat” architecture comprising radio network nodes connected directly to one or more CNs, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

The current 5G RAN (NG-RAN) architecture is depicted in FIG. 1a, which illustrates the overall NG RAN architecture, and is described in TS 38.401v15.5.0 (http://www.3gpp.org/ftp//Specs/archive/38_series/38.401/38401-f50.zip).

The NG architecture can be further described as follows:
The NG-RAN consists of a set of gNBs connected to the 5GC through the NG.
A gNB can support FDD mode, TDD mode or dual mode operation.
gNBs can be interconnected through the Xn.
A gNB may consist of a gNB-CU and gNB-DUs. A gNB-CU and a gNB-DU is connected via F1 logical interface.
One gNB-DU is connected to only one gNB-CU.
NOTE: For resiliency, a gNB-DU may be connected to multiple gNB-CU by appropriate implementation.

NG, Xn and F1 are logical interfaces. The NG-RAN is layered into a Radio Network Layer (RNL) and a Transport Network Layer (TNL). The NG-RAN architecture, i.e. the NG-RAN logical nodes and interfaces between them, is defined as part of the RNL. For each NG-RAN interface (NG, Xn, F1) the related TNL protocol and the functionality are specified. The TNL provides services for user plane transport and signalling transport. If security protection for control plane and user plane data on TNL of NG-RAN interfaces has to be supported, NDS/IP (3GPP TS 33.401 [x] shall be applied).

A gNB may also be connected to an LTE eNB via the EN-DC X2 interface. Another architectural option is that where an LTE eNB connected to the Evolved Packet Core network is connected over the EN-DC X2 interface with a so called en-gNB. The latter is a gNB not connected directly to a CN and connected via EN-DC X2 to an eNB for the sole purpose of performing dual connectivity. This is shown in FIG. 1b, which illustrates the overall E-UTRAN architecture for EN-DC.

The architecture in FIG. 1a can be expanded by spitting the gNB-CU into two entities. In the split architecture option, the RAN protocol stack functionality is separated in different parts. The CU-CP is expected to handle the RRC layer, the CU-UP will handle the PDCP layer and the DU will handle the RLC, MAC and PHY layer of the protocol stack. In some further split the DU can have separated unit that handles the PHY parts separately compared to RLC and MAC layers that are handled in a DU. See FIG. 2.

As different units handle different protocol stack functionalities, there will be a need for inter-node communication between the DU, the CU-UP and the CU-CP. This is achieved via F1-C interface related to control plane signaling, via F1-U interface related to user plane signaling for communication between CU and DU and via E1 for communication between CU-UP and CU-CP.
The E1 interface is a logical interface. It supports the exchange of signalling information between the endpoints. From a logical standpoint, the E1 is a point-to-point interface between a gNB-CU-CP and a gNB-CU-UP. The E1 interface enables exchange of UE associated information and non-UE associated information. The E1 interface is a control interface and is not used for user data forwarding.

During setup of an EN-DC X2 interface and of an Xn interface, the current standard imposes an eNB (for EN-DC X2 Setup) and an NG-RAN node (for Xn Setup) to receive the full list of cells served by an en-gNB or a gNB. While this decision was taken to allow the receiving node to have a full view of the cells served by the en-gNB/gNB, the decision was also taken under the assumption that the actual number of cells served by an en-gNB/gNB would be contained. Below are excerpts of the EN-DC X2 Setup Request/Response messages and of the Xn Setup Request/Response messages.

From TS 36.423 v15.6.0:

9.1.2.31 EN-DC X2 SETUP REQUEST

This message is sent by an initiating node to a neighbouring node, both nodes able to interact for EN-DC, to transfer the initialization information for a TNL association.

Direction: eNB→en-gNB, en-gNB→eNB.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| CHOICE Initiating | M | | | | | |
| NodeType | | | | | | |
| >eNB | | | | | | |
| >>Global | M | | 9.2.22 | | YES | reject |
| eNB ID | | | | | | |
| >>List | | 1 . . . | | Complete list | YES | reject |
| of Served | | <maxCellineNB> | | of cells served | | |
| E-UTRA Cells | | | | by the eNB | | |
| >>>Served | M | | Served Cell | | — | |
| E-UTRA Cell | | | Information | | | |
| Information | | | 9.2.8 | | | |
| >>>NR | O | | 9.2.98 | NR neighbours | YES | ignore |
| Neighbour | | | | | | |
| Information | | | | | | |
| >en-gNB | | | | | | |
| >>Global | M | | 9.2.112 | | YES | reject |
| en-gNB ID | | | | | | |
| >>List | | 1 . . . | | Complete list | YES | reject |
| of Served | | <maxCellinengNB> | | of cells served | | |
| NR Cells | | | | by the engNB. | | |
| >>>Served | M | | 9.2.110 | | | |
| NR Cell | | | | | | |
| Information | | | | | | |
| >>>NR | O | | 9.2.98 | NR neighbours. | YES | ignore |
| Neighbour | | | | | | |
| Information | | | | | | |
| Interface | O | | 9.2.143 | | YES | reject |
| Instance | | | | | | |
| Indication | | | | | | |

| Range bound | Explanation |
|---|---|
| maxCellineNB | Maximum no. cells that can be served by an eNB. Value is 256. |
| maxCellinengNB | Maximum no. cells that can be served by an en-gNB. Value is 16384. |

9.1.2.32 EN-DC X2 SETUP RESPONSE

This message is sent by a neighbouring node to an initiating node, both nodes able to interact for EN-DC, to transfer the initialization information for a TNL association.

Direction: eNB→en-gNB, en-gNB→eNB.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| CHOICE Responding | M | | | | | |
| NodeType | | | | | | |
| >eNB | | | | | | |
| >>Global | M | | 9.2.22 | | YES | reject |
| eNB ID | | | | | | |
| >>List | | 1 . . . | | Complete list | YES | reject |
| of Served | | <maxCellineNB> | | of cells served | | |
| E-UTRA Cells | | | | by the eNB | | |
| >>>Served | M | | Served Cell | | — | |
| E-UTRA Cell | | | Information | | | |
| Information | | | 9.2.8 | | | |
| >>>NR | O | | 9.2.98 | NR neighbours | YES | ignore |
| Neighbour | | | | | | |
| Information | | | | | | |
| >en-gNB | | | | | | |
| >>Global | M | | 9.2.112 | | YES | reject |
| en-gNB ID | | | | | | |
| >>List | | 1 . . . | | Complete list | YES | reject |
| of Served | | <maxCellinengNB> | | of cells served | | |
| NR Cells | | | | by the en-gNB | | |
| >>>Served | M | | 9.2.110 | | — | |
| NR Cell | | | | | | |
| Information | | | | | | |
| >>>NR | O | | 9.2.98 | NR neighbours | YES | ignore |
| Neighbour | | | | | | |
| Information | | | | | | |
| Interface | O | | 9.2.143 | | YES | reject |
| Instance | | | | | | |
| Indication | | | | | | |

| Range bound | Explanation |
|---|---|
| maxCellineNB | Maximum no. cells that can be served by an eNB. Value is 256. |
| maxCellinengNB | Maximum no. cells that can be served by an en-gNB. Value is 16384. |

9.1.2.33 EN-DC X2 SETUP FAILURE

This message is sent by the neighbouring node to indicate EN-DC X2 Setup failure. Direction: eNB→en-gNB, en-gNB→eNB.

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.2.13 | YES | reject |
| Cause | M | 9.2.6 | YES | ignore |
| Criticality | O | 9.2.7 | YES | ignore |
| Diagnostics | | | | |
| Time To Wait | O | 9.2.32 | YES | ignore |
| Interface | O | 9.2.143 | YES | reject |
| Instance | | | | |
| Indication | | | | |

From TS 38.423v15.4.0:

9.1.3.1 XN SETUP REQUEST

This message is sent by a NG-RAN node to a neighbouring NG-RAN node to transfer application data for an Xn-C interface instance.

Direction: NG-RAN node₁→NG-RAN node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Global NG-RAN | M | | 9.2.2.3 | | YES | reject |
| Node ID | | | | | | |
| TAI Support List | M | | 9.2.3.20 | List of | YES | reject |
| | | | | supported | | |
| | | | | TAs and | | |
| | | | | associated | | |
| | | | | characteristics. | | |
| AMF Region | M | | 9.2.3.83 | List of all the | YES | reject |
| Information | | | | AMF Regions | | |
| | | | | to which the | | |
| | | | | NG-RAN node | | |
| | | | | belongs. | | |
| List of | | 0 . . . | | Complete list | YES | reject |
| Served | | <maxnoofCellsinNG- | | of cells served | | |
| Cells NR | | RAN node> | | by the gNB | | |
| >Served Cell | M | | 9.2.2.11 | | — | |
| Information NR | | | | | | |
| >Neighbour | O | | 9.2.2.13 | | — | |
| Information NR | | | | | | |
| >Neighbour | O | | 9.2.2.14 | | — | |
| Information | | | | | | |
| E-UTRA | | | | | | |
| List of | | 0 . . . | | Complete list | YES | reject |
| Served Cells | | <maxnoofCellsinNG- | | of cells served | | |
| E-UTRA | | RAN node> | | by the ng-eNB. | | |
| >Served Cell | M | | 9.2.2.12 | | — | |
| Information | | | | | | |
| E-UTRA | | | | | | |
| >Neighbour | O | | 9.2.2.13 | | — | |
| Information NR | | | | | | |
| >Neighbour | O | | 9.2.2.14 | | — | |
| Information | | | | | | |
| E-UTRA | | | | | | |
| Interface | O | | 9.2.2.39 | | YES | reject |
| Instance | | | | | | |
| Indication | | | | | | |

| Range bound | Explanation |
|---|---|
| maxnoofCellsinNG-RAN node | Maximum no. cells that can be served by a NG-RAN node. Value is 16384. |

9.1.3.2 XN SETUP RESPONSE

This message is sent by a NG-RAN node to a neighbouring NG-RAN node to transfer application data for an Xn-C interface instance.

Direction: NG-RAN node₂→NG-RAN node₁.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Global NG-RAN | M | | 9.2.2.3 | | YES | reject |
| Node ID | | | | | | |
| TAI Support List | M | | 9.2.3.20 | List of | YES | reject |
| | | | | supported | | |
| | | | | TAs and | | |
| | | | | associated | | |
| | | | | characteristics. | | |
| List of | | 0 . . . | | Complete list | YES | reject |
| Served | | <maxnoofCellsinNG- | | of cells served | | |
| Cells NR | | RAN node> | | by the gNB | | |
| >Served Cell | M | | 9.2.2.11 | | — | |
| Information NR | | | | | | |
| >Neighbour | O | | 9.2.2.13 | | — | |
| Information NR | | | | | | |
| >Neighbour | O | | 9.2.2.14 | | — | |
| Information | | | | | | |
| E-UTRA | | | | | | |
| List of | | 0 . . . | | Complete list | YES | reject |
| Served Cells | | <maxnoofCellsinNG- | | of cells served | | |
| E-UTRA | | RAN node> | | by the ng-eNB | | |
| >Served Cell | M | | 9.2.2.12 | | — | |
| Information | | | | | | |
| E-UTRA | | | | | | |
| >Neighbour | O | | 9.2.2.13 | | — | |
| Information NR | | | | | | |
| >Neighbour | O | | 9.2.2.14 | | — | |
| Information | | | | | | |
| E-UTRA | | | | | | |
| Criticality | O | | 9.2.3.3 | | YES | ignore |
| Diagnostics | | | | | | |
| AMF Region | O | | 9.2.3.83 | List of all the | YES | reject |
| Information | | | | AMF Regions | | |
| | | | | to which the | | |
| | | | | NG-RAN node | | |
| | | | | belongs. | | |
| Interface | O | | 9.2.2.39 | | YES | reject |
| Instance | | | | | | |
| Indication | | | | | | |

| Range bound | Explanation |
|---|---|
| maxnoofCellsinNG-RAN node | Maximum no. cells that can be served by a NG-RAN node. Value is 16384. |

9.1.3.3 XN SETUP FAILURE

This message is sent by the neighbouring NG-RAN node to indicate Xn Setup failure.

Direction: NG-RAN node₂→NG-RAN node,.

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.2.3.1 | YES | reject |
| Cause | M | 9.2.3.2 | YES | ignore |
| Time To Wait | O | 9.2.3.56 | YES | ignore |
| Criticality | O | 9.2.3.3 | YES | ignore |
| Diagnostics | | | | |
| Interface | O | 9.2.2.39 | YES | reject |
| Instance | | | | |
| Indication | | | | |

Mass deployment of 5G networks is now a very close reality and with that it is emerging that some implementations support very high amounts of cells at en-gNBs and gNBs. This creates a scalability problem, with building, transporting and decoding very big messages.

### SUMMARY

It is in view of the above background and other considerations that the various embodiments of the present disclosure have been made. As a part of developing embodiments herein a problem has been identified, which first will be discussed.

A network node receiving a full list of served cells may not be able to process the message due to its very large size. An EN-gNB and a gNB may e.g. support a maximum of 16384 cells. When an EN-DC X2 Setup Request/Response is issued by an en-gNB or when an Xn Setup Request/Response is issued by a gNB, the message may contain a List of Served NR Cells IE of up to 16384 cells. For each of the listed NR cells there could be a list of neighbouring cells, the NR Neighbour Information IE, which could reach a maximum of 1024 neighbour cells. The result is a potential maximum of 16384×1024==16.777.216 cell information in one ASN.1 encoded message.

An object of embodiments herein is therefore to provide an efficient signalling for communication in a wireless communication network.

According to a first aspect of the present disclosure, the object is achieved by a method, performed by a first network node, for handling communication in a wireless communication network. The method comprises the step of transmitting, to a second network node, a message related to a connection establishment between the first network node and the second network node. The message comprises at least one of: a first indication indicating whether a list of served cells of the first network node comprised in the message is a partial list of cells; a second indication indicating a maximum number of cells in a list of served cells of the second network node that the first network node can receive; and a third indication indicating a reason for a failure of the connection establishment.

In some embodiment, the transmitted message is at least one of an EN-DC X2 Setup Request message, an EN-DC X2 Setup Response message, an Xn Setup Request message and an Xn Setup Response message. The transmitted message may, for example, comprise the first indication and the first indication may be a Partial List Indicator Information Element (IE).

In some embodiment, the transmitted message is at least one of an EN-DC X2 Setup Failure message and an Xn Setup Failure message. The transmitted message may, for example, comprise the third indication and the third indication may be a Message Oversize Notification IE.

In some embodiments, the transmitted message comprises the second indication and wherein the second is a Maximum Cell List Size IE.

According to an aspect of embodiments herein, the object is achieved by a method performed by a first network node for handling communication in a wireless communication network. The first network node transmits to a second network node a message related to a connection establishment between the first and second network node. The message comprises: a first indication that a list of served cells of the first network node comprised in the message is complete or not complete; a second indication of a capacity of a maximum size of a list of served cells of the second network node comprised in a message; and/or a third indication of a reason for a failure of the connection establishment.

According to another aspect of the present disclosure, the object is achieved by a method, performed by a second network node, for handling communication in a wireless communication network. The method comprises the step of receiving, from a first network node, a message related to a connection establishment between the first network node and the second network node. The message comprises at least one of: a first indication indicating whether a list of served cells of the first network node comprised in the message is a partial list of cells; a second indication indicating a maximum number of cells in a list of served cells of the second network node that the first network node can receive; and a third indication indicating a reason for a failure of the connection establishment.

In some embodiments, the method further comprises the step of handling the connection establishment based on the first, second and/or third indication.

In some embodiments, the received message is at least one of an EN-DC X2 Setup Request message, an EN-DC X2 Setup Response message, an Xn Setup Request message and an Xn Setup Response message. The received message may, for example, comprise the first indication and the first indication may be a Partial List Indicator IE.

In some embodiments, the received message is at least one of an EN-DC X2 Setup Failure message and an Xn Setup Failure message. The received message may, for example, comprise the third indication and the third indication may be a Message Oversize Notification IE.

In some embodiments, the received message comprises the second indication and wherein the second is a Maximum Cell List Size IE.

According to another aspect of embodiments herein, the object is achieved by a method performed by a second network node for handling communication in a wireless communication network. The second network node receives from a first network node a message related to a connection establishment between the first and second network node. The message comprises: a first indication that a list of served cells of the first network node comprised in the message is complete or not complete; a second indication of a capacity of a maximum size of a list of served cells of the second network node comprised in a message; and/or a third indication of a reason for a failure of the connection establishment. The second network node may then handle connection establishment based on the first, second, and/or third indication.

According to a further aspect of the present disclosure, the object is achieved by a first network node for handling communication in a wireless communication network. The first network node is configured to transmit, to a second network node, a message related to a connection establishment between the first network node and the second network node. The message comprises at least one of: a first indication indicating whether a list of served cells of the first network node comprised in the message is a partial list of cells; a second indication indicating a maximum number of cells in a list of served cells of the second network node that the first network node can receive; and a third indication indicating a reason for a failure of the connection establishment.

In some embodiments, the transmitted message is at least one of an EN-DC X2 Setup Request message, an EN-DC X2 Setup Response message, an Xn Setup Request message and an Xn Setup Response message. The transmitted message may, for example, comprise the first indication and the first indication may be a Partial List Indicator IE.

In some embodiments, the transmitted message is at least one of an EN-DC X2 Setup Failure message and an Xn Setup Failure message. The transmitted message may, for example, comprise the third indication and the third indication may be a Message Oversize Notification IE.

In some embodiments, the transmitted message comprises the second indication and wherein the second is a Maximum Cell List Size IE.

In some embodiments, the first network node is an eNB or an gNB.

According to a further aspect of embodiments herein, the object is achieved by a first network node, configured to transmit to a second network node a message related to a connection establishment between the first and second network node. The message comprises: a first indication that a list of served cells of the first network node comprised in the message is complete or not complete; a second indication of a capacity of a maximum size of a list of served cells of the second network node comprised in a message; and/or a third indication of a reason for a failure of the connection establishment.

According to a yet further aspect of the present disclosure, the object is achieved by a second network node for handling communication in a wireless communication network. The second network node is configured to receive, from a first network node, a message related to a connection establishment between the first network node and the second network node. The message comprises at least one of: a first indication indicating whether a list of served cells of the first network node comprised in the message is a partial list of cells; a second indication indicating a maximum number of cells in a list of served cells of the second network node that the first network node can receive; and a third indication indicating a reason for a failure of the connection establishment.

In some embodiments, the second network node is further configured to handle the connection establishment based on the first, second and/or third indication.

In some embodiments, the received message is at least one of an EN-DC X2 Setup Request message, an EN-DC X2 Setup Response message, an Xn Setup Request message and an Xn Setup Response message. The received message may, for example, comprise the first indication and the first indication may be a Partial List Indicator IE.

In some embodiments, the received message is at least one of an EN-DC X2 Setup Failure message and an Xn Setup Failure message. The received message may, for example, comprise the third indication and the third indication may be a Message Oversize Notification IE.

In some embodiments, the received message comprises the second indication and wherein the second is a Maximum Cell List Size IE.

In some embodiments, the second network node is an eNB or a gNB.

According to a yet further aspect of embodiments herein, the object is achieved by a second network node configured to receive from a first network node a message related to a connection establishment between the first and second network node. The message comprises: a first indication that a list of served cells of the first network node comprised in the message is complete or not complete; a second indication of a capacity of a maximum size of a list of served cells of the second network node comprised in the message; and/or a third indication of a reason for a failure of the connection establishment. The second network node may further be configured to handle connection establishment based on the first, second, and/or third indication.

According to an aspect of the present disclosure, the object is achieved by a computer program comprising instructions, which when executed by a processor, causes the processor to perform actions according to any of the methods according to the preciously described aspects.

According to a further aspect of the present disclosure, the object is achieved by a carrier comprising the computer program of the previously described aspect, wherein the carrier is one of an electronic signal, an optical signal, an electromagnetic signal, a magnetic signal, an electric signal, a radio signal, a microwave signal, or a computer-readable storage medium.

The performance of wireless communication network may be improved according to the embodiments above, e.g. since the first, second, third indications are all related to the size of the list of served cells of network nodes and they all affect the size of the list sent. Thus, reducing the amount of data sent between the network node where some or most of contents of the message is not relevant to the receiving network node.

Yet another advantage of embodiments herein is that the suggested solution suggests an improvement to mitigate problems with large messages related to connection establishment, such as EN-DC X2 setup and Xn setup request and response messages, due to a large amount of served cell information and neighbour information. The solution allows the correct establishment of e.g. EN-DC X2 and Xn interfaces without incurring in failures due to too large messages.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1a shows an overall NG RAN architecture.

FIG. 1b shows an overall E-UTRAN architecture for EN-DC.

FIG. 2 illustrates a split architecture option.

FIG. 3 is a schematic overview of a wireless communications network.

FIG. 4a shows eNB Initiated EN-DC X2 Setup, successful operation.

FIG. 4b shows en-gNB Initiated EN-DC X2 Setup, successful operation.

FIG. 5a illustrates eNB Initiated EN-DC X2 Setup, unsuccessful operation.

FIG. 5b illustrates en-gNB Initiated EN-DC X2 Setup, unsuccessful operation.

FIG. 6a shows eNB Initiated EN-DC Configuration Update, successful operation.

FIG. 6b shows en-gNB Initiated EN-DC Configuration Update, successful operation.

FIG. 7a illustrates eNB Initiated EN-DC Configuration Update, unsuccessful operation.

FIG. 7b illustrates en-gNB Initiated EN-DC Configuration Update, unsuccessful operation.

FIG. 8a illustrates a combined signalling diagram and flowchart showing involved nodes.

FIG. 8b is a flow chart according to embodiments herein.

FIG. 8c is a flow chart according to embodiments herein.

FIG. 9 are schematic drawings illustrating an example of a first network node.

FIG. 10 are schematic drawings illustrating an example of a second network node.

FIG. 11 is a schematic block diagram illustrating a telecommunication network connected via an intermediate network to a host computer.

FIG. 12 is a schematic block diagram of a host computer communicating via a base station with a UE over a partially wireless connection.

FIG. 13 is a flowchart depicting embodiments of a method in a communications system comprising a host computer, a base station and a UE.

FIG. 14 is a comprising depicting embodiments of a method in a communications system comprising a host computer, a base station and a UE.

FIG. 15 is a flowchart depicting embodiments of a method in a communications system comprising a host computer, a base station and a UE.

FIG. 16 is a flowchart depicting embodiments of a method in a communications system comprising a host computer, a base station and a UE.

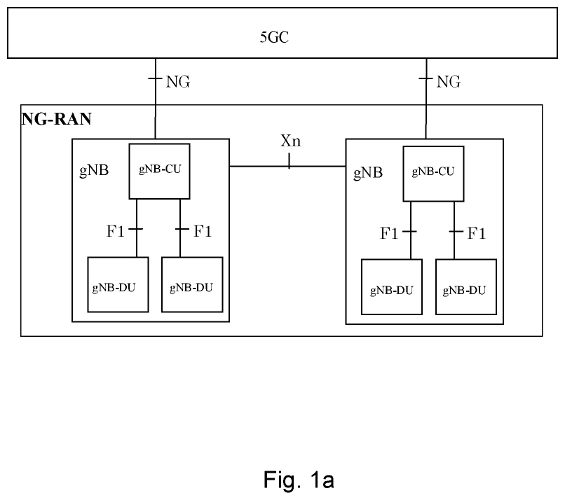

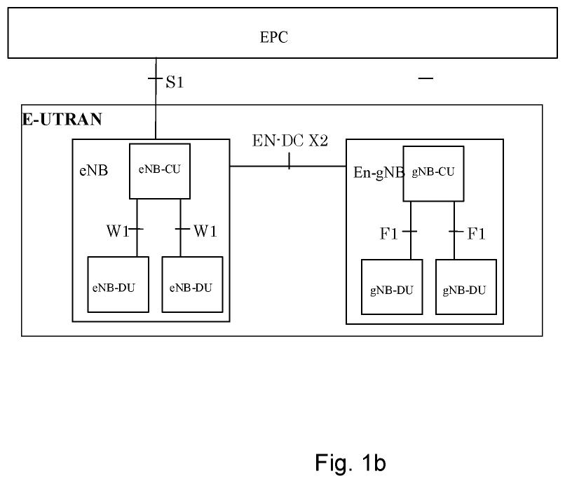

The drawings are not necessarily to scale and the dimensions of certain features may have been exaggerated for the sake of clarity. Emphasis is instead placed upon illustrating the principle of the embodiments herein.

### DETAILED DESCRIPTION

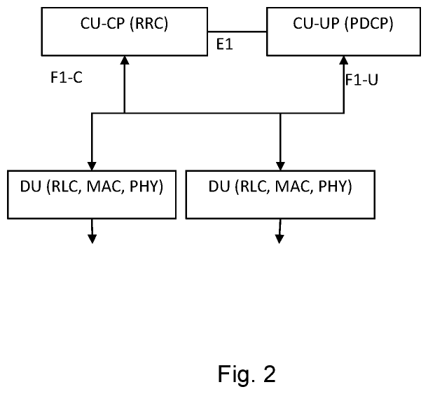

Embodiments herein relate to wireless communications networks in general. FIG. 3 is a schematic overview depicting a wireless communications network 300. The wireless communications network 300 comprises one or more RANs and one or more CNs. The wireless communications network 300 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 300, a user equipment (UE) 310 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 300 comprises a first radio network node 320 providing radio coverage over a geographical area, a first service area, of a first radio access technology (RAT), such as NR, LTE, or similar. The radio network node 320 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the wireless device in form of DL transmissions to the wireless device and UL transmissions from the wireless device.

The wireless communications network 300 comprises further a second network node 330 providing radio coverage over a geographical area, a second service area, of a second radio access technology (RAT), such as NR, LTE, or similar. The second network node 330 may be a transmission and reception point such as an access node, an access controller, a radio network node, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the second network node depending e.g. on the second radio access technology and terminology used. The second network node 330 may be referred to as a secondary network node wherein the service area may be referred to as a served cell, and the second network node 330 communicates with the UE 310 in form of DL transmissions to a UE and UL transmissions from the UE 310. It should be noted that a service area may be denoted as cell, beam, beam group or similar to define an area of radio coverage.

The first and second network nodes 320, 330 may initiate to establish a connection such as an X2 or Xn connection between the first and second network nodes 320, 330. Embodiments herein relate to communication of a list of served cells of respective network node, wherein the size of the list is taken into consideration when generating the list. The first network node 320 transmits a message related to the connection establishment between the first and second network node 320, 330. The message comprises: a first indication that a list of served cells of the first network node comprised in the message is complete or not complete, i.e. the first indication indicates whether the list of served cells of the first network node 320 comprised in the message is a partial list of cells; a second indication of a capacity of a maximum size of a list of served cells of the second network node comprised in a message; and/or a third indication of a reason for a failure of the connection establishment. Accordingly, the message comprise at least one of the first indication, the second indication and the third indication.

Embodiments herein allow a reduction of number of served cells sent in the message related to connection establishment, such as X2 messages, from a network node, such as a gNB, which reduces the size of the message. Embodiments herein may also make it possible to convey served cell information to network nodes that have limited capacity and do not need the full cell list.

Embodiments herein may be based on one or more of the following methods
The first assumption is that the mandate for a node to send a full list of cells during EN-DC X2 Setup and Xn Setup procedures shall be lifted. Note that it may be possible for an eNB to still send its full list of cells because that list is limited to a maximum of 256 cells. The first indication such as a flag indicating whether the list of served cells is full or partial may be added to a message related to connection establishment, to allow for clear interpretation of the received information. For example to allow the receiving second network node 13 to deduce that more, undeclared cells, are served by the sending first network node 12 and that there might be the need for extra procedures to trigger discovering of these cells.
The message related to connection establishment such as setup messages e.g. EN-DC X2 Setup Request and Xn Setup Request may be enhanced with the second indication of a maximum cell list size the sending first network node 320 is able to receive. This allows the receiving second network node 330 to deduce what are the limitations in terms of message size reception and decoding capabilities at the other peer node. Hence, with this information failures due to too large messages can be avoided since the size of the list may be based on the received second indication.
The message related to connection establishment such as setup failure messages, e.g. EN-DC X2 Setup Failure and Xn Setup Failure messages, may include the third indication of failure due to too large message size as well as an indication of the maximum cell list size the node triggering the failure is able to receive. This allows the receiving second network node 330 to deduce the cause of the failure as well as the limitations in terms of message size reception and decoding capabilities at the first network node 320 where the failure occurred. Hence, with this information failures due to too large messages for future procedures of EN-DC Setup and Xn Setup can be avoided.

An en-gNB and a gNB can support a maximum of 16384 cells. When an EN-DC X2 Setup Request/Response is issued by an en-gNB or when an Xn Setup Request/Response is issued by a gNB, the message may contain a List of Served NR Cells IE of up to 16384 cells. For each of the listed NR cells there could be a list of neighbouring cells, the NR Neighbour Information IE, which could reach a maximum of 1024 neighbour cells. The result is a potential maximum of 16384×1024==16.777.216 cell information in one ASN.1 encoded message.

It is up to implementation how to dimension the memory of an eNB/NG-RAN node. Such memory would need to be dimensioned to allow storage of the full ASN.1 encoded message in order to allow the node to decode it correctly. However, given the very high number of cells that could be listed in the messages in question, it should be acknowledged that there might be implementations where the overall available memory in a RAN node may not be sufficient to host a message with a high number of cells information.

Hence there might be implementations that are not able to correctly decode messages with very high numbers of cells information due to memory and ASN.1 decoding capacity limitations.

In light of the above conclusion, the standard should address the case where an eNB or an NG-RAN node receives an “oversized” EN-DC X2 Setup Request/Response or Xn Setup Request/Response message. Namely, there should be solutions where the procedure is not simply rejected, because that alternative would lead to making it impossible to setup an interface at all between the nodes involved.

In order to achieve such solution one method of this invention proposes to avoid that the EN-DC X2 Setup Request/Response and Xn Setup Request/Response contain a full list of cells. In EN-DC it could still be feasible that an eNB responds with a full list of cells because the maximum number of cells an eNB can support is 256, i.e. a limited number. However, in all other cases, where the maximum number of supported cells is 16384, the method assumes that it is not mandated that the interface setup procedure includes a full list of cells. In order to have a clear understanding between the two nodes communicating to setup the interface, the method proposes that a new flag may be added by the node sending a message its list of served cells, indicating whether the list of cells included in the setup procedure is full or partial.

The method therefore proposes an enhancement to the current EN-DC X2 and Xn specifications to remove the mandate for a node to send a full list of cells during EN-DC X2 Setup and Xn Setup procedures. eNBs in EN-DC X2 Setup can still provide a full list of cells as it is of limited size. A flag indicating whether the list of served cells is full or partial may be added to EN-DC X2 Setup and Xn Setup messages, to allow for clear interpretation of the received information.

In another method of this invention the EN-DC Setup Request and Xn Setup Request may also be enhanced with information on the maximum message size the sending node can support. Namely, a node sending an EN-DC X2 Setup request, for example, may be able to indicate to the peer node that it would like to receive back a limited list of cells. This would avoid decoding issues when receiving the response message.

This second method therefore proposes that the EN-DC X2 Setup Request and Xn Setup Request may be enhanced with an indication of the maximum cell list size for the served cells listed in each message, that the sending node is able to receive.

In yet another method, the EN-DC X2 Setup Failure and the Xn Setup Failure messages may be enhanced with indications that the procedure has failed due to too large message size. This would allow the node receiving the failure message to determine that any future interface setup towards the peer node need to be performed with a reduced message size, i.e. by including a reduced number of served cells. Additionally, the messages could also include information regarding the maximum number of cells the node generating the failure can receive as part of the served cell information. This allows that, in future attempts of EN-DC X2 and Xn establishments the node triggering the procedure signals information for served cells in a number that is within the limits indicated by the node where the failure occurred.

Hence, this method proposes that the EN-DC X2 Setup Failure and Xn Setup Failure messages may include an indication of failure due to too large message size as well as with an indication of the maximum cell list size for the served cells listed in each message, that the node where the failure occurred is able to receive.

The following section contains a copy of the suggested change in the 3GPP specification 36.423 v15.5.0. This also describes the suggested invention. The impacted/changed parts compared to the 3GPP TS document 36.423 v15.5.0 are marked in italics. Added text is underlined and deleted text striked through.

In the following the invention is described for the case of EN-DC X2 interface between an eNB and an en-gNB. The solution is not limited to this, but may also be used on other interfaces such as X2, and Xn and between other pairs of nodes such as eNB-eNB, gNB-gNB, gNB-ng-eNB and ng-eNB-ng-eNB.

First Change

5.1 8.7 Procedures for E-UTRAN-NR Dual Connectivity

5.1.1 8.7.1 EN-DC X2 Setup

5.1.1.1 8.7.1.1 General

The purpose of the EN-DC X2 Setup procedure is to exchange application level configuration data needed for eNB and en-gNB to interoperate correctly over the X2 interface. This procedure erases any existing application level configuration data in the two nodes and replaces it by the one received. This procedure also resets the X2 interface like a Reset procedure would do.

NOTE: If X2-C signalling transport is shared among multiple X2-C interface instances, one EN-DC X2 Setup procedure is issued per X2-C interface instance to be setup, i.e. several X2 Setup procedures may be issued via the same TNL association after that TNL association has become operational.

The procedure uses non UE-associated signalling.

5.1.1.2 8.7.1.2 Successful Operation

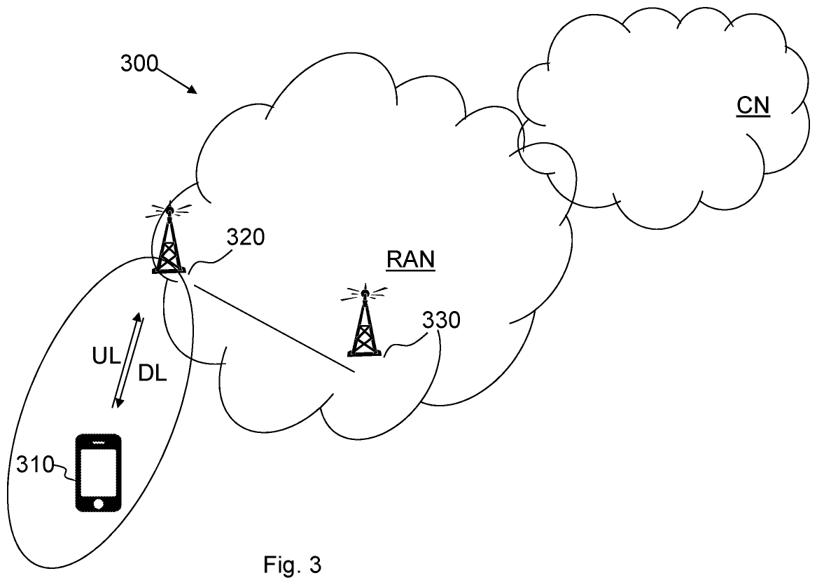

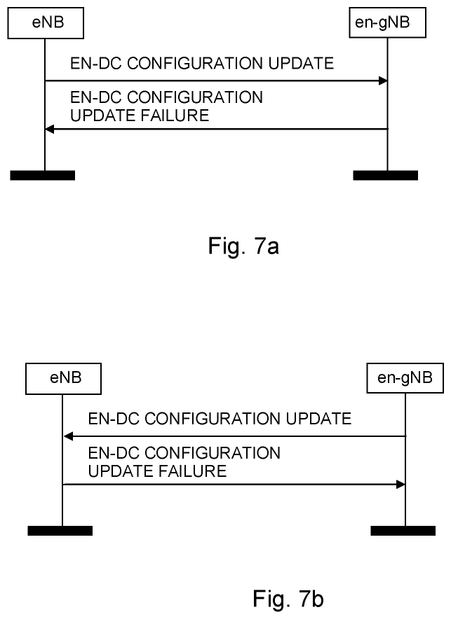

FIG. 4a (corresponding to FIG. 8.7.1.2-1 in 36.423 v15.5.0) depicts eNB Initiated EN-DC X2 Setup, successful operation. FIG. 4b (corresponding to FIG. 8.7.1.2-2 in 36.423 v15.5.0) depicts en-gNB Initiated EN-DC X2 Setup, successful operation.

If case of network sharing with multiple cell ID broadcast with shared X2-C signalling transport, as specified in TS 36.300 [15], the EN-DC X2 SETUP REQUEST message and the EN-DC X2 SETUP RESPONSE message shall include the Interface Instance Indication IE to identify the corresponding interface instance.

eNB Initiated EN-DC X2 Setup:

An eNB initiates the procedure by sending the EN-DC X2 SETUP REQUEST message to a candidate en-gNB. The candidate en-gNB replies with the EN-DC X2 SETUP RESPONSE message. The initiating eNB shall transfer the complete list of its served cells to the candidate en-gNB. If the Partial List Indicator IE is set to “partial” in the EN-DC X2 SETUP RESPONSE message from the candidate en-gNB, the initiating eNB shall assume that the candidate en-gNB has included in the List of Served NR Cells IE a partial list of cells. If Supplementary Uplink is configured at the candidate en-gNB, the candidate en-gNB may include in the EN-DC X2 SETUP RESPONSE message the SUL Information IE and the Supported SUL band List IE for each served cell where supplementary uplink is configured.

If the EN-DC X2 SETUP REQUEST message contains the Protected E-UTRA Resource Indication IE, the receiving en-gNB may take this into account for cell-level resource coordination with the eNB. The en-gNB shall consider the received Protected E-UTRA Resource Indication IE content valid until reception of a new update of the IE for the same eNB.

The protected resource pattern indicated in the Protected E-UTRA Resource Indication IE is not valid in subframes indicated by the Reserved Subframes IE, as well as in the non-control region of the MBSFN subframes i.e. it is valid only in the control region therein. The size of the control region of MBSFN subframes is indicated in the Protected E-UTRA Resource Indication IE.

If the EN-DC X2 SETUP REQUEST message contains the Maximum Cell List Size IE, the candidate en-gNB shall take it into account and include in the EN-DC X2 SETUP RESPONSE message a total number of served cells equal or lower than the Maximum Cell List Size IE value.

en-gNB Initiated EN-DC X2 Setup:

An en-gNB initiates the procedure by sending the EN-DC X2 SETUP REQUEST message to a candidate eNB. The candidate eNB replies with the EN-DC X2 SETUP RESPONSE message. If the Partial List Indicator IE is set to “partial” in the EN-DC X2 SETUP REQUEST message the candidate eNB shall assume that the initiating en-gNB has included in the List of Served NR Cells IE a partial list of cells. The initiating en-gNB may transfer the complete list of its served cells to the candidate eNB. The candidate eNB shall reply with the complete list of its served cells.

If Supplementary Uplink is configured at the en-gNB, the en-gNB shall include in the EN-DC X2 SETUP REQUEST message the SUL Information IE and the Supported SUL band List IE for each served cell where supplementary uplink is configured.

If the EN-DC X2 SETUP RESPONSE message contains the Protected E-UTRA Resource Indication IE, the receiving en-gNB may take this into account for cell-level resource coordination with the eNB. The en-gNB shall consider the received Protected E-UTRA Resource Indication IE content valid until reception of a new update of the IE for the same eNB.

5.1.1.3 8.7.1.3 Unsuccessful Operation

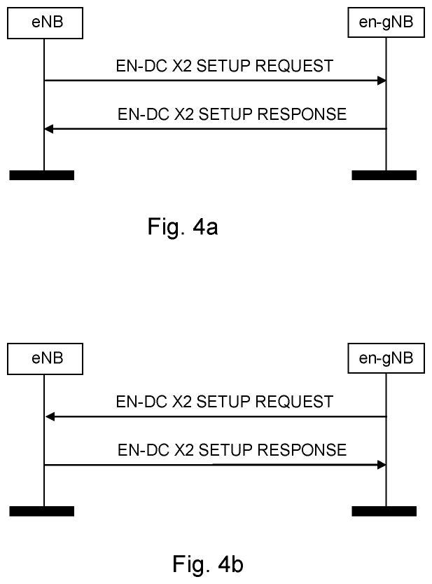

FIG. 5a (corresponding to FIG. 8.7.1.3-1 in 36.423 v15.5.0) depicts eNB Initiated EN-DC X2 Setup, unsuccessful operation. FIG. 5b depicts en-gNB Initiated EN-DC X2 Setup, unsuccessful operation (corresponding to FIG. 8.7.1.3-1 in 36.423 v15.5.0).

If the candidate receving node cannot accept the setup it shall respond with an EN-DC X2 SETUP FAILURE message with appropriate cause value. If the Message Oversize Notification IE is included in the EN-DC X2 SETUP FAILURE, the initiating node shall deduce that the failure is due to a too large EN-DC X2 SETUP REQUEST message. The initiating node shall reduce the size of the EN-DC X2 SETUP REQUEST message in following EN-DC X2 Setup attempts. If the Maximum Cell List Size IE is present in the EN-DC X2 SETUP FAILURE, the initiating node shall ensure that the total number of served cells in following EN-DC X2 SETUP REQUEST message is equal to or lower than the value of the Maximum Cell List Size IE.

If case of network sharing with multiple cell ID broadcast with shared X2-C signalling transport, as specified in TS 36.300 [15], the EN-DC X2 SETUP REQUEST message and the EN-DC X2 SETUP FAILURE message shall include the Interface Instance Indication IE to identify the corresponding interface instance.

5.1.1.4 8.7.1.4 Abnormal Conditions

If the first message received for a specific TNL association is not an EN-DC X2 SETUP REQUEST, EN-DC X2 SETUP RESPONSE, or EN-DC X2 SETUP FAILURE message then this shall be treated as a logical error.

If the initiating node does not receive either EN-DC X2 SETUP RESPONSE message or EN-DC X2 SETUP FAILURE message, the initiating node may reinitiate the EN-DC X2 Setup procedure towards the same candidate node, provided that the content of the EN-DC X2 SETUP REQUEST message is identical to the content of the previously unacknowledged EN-DC X2 SETUP REQUEST message.

If the EN-DC X2 SETUP FAILURE message includes the Time To Wait IE the initiating node shall wait at least for the indicated time before reinitiating the EN-DC X2 Setup procedure towards the same peer node.

If the initiating node receives an EN-DC X2 SETUP REQUEST message from the peer entity on the same X2 interface:
In case the initiating node answers with an EN-DC X2 SETUP RESPONSE message and receives a subsequent EN-DC X2 SETUP FAILURE message, the initiating node shall consider the X2 interface as non operational and the procedure as unsuccessfully terminated according to sub clause 8.7.1.3.
In case the initiating node answers with an EN-DC X2 SETUP FAILURE message and receives a subsequent EN-DC X2 SETUP RESPONSE message, the initiating node shall ignore the EN-DC X2 SETUP RESPONSE message and consider the X2 interface as non operational.

5.1.2 8.7.2 EN-DC Configuration Update

5.1.2.1 8.7.2.1 General

The purpose of the EN-DC Configuration Update procedure is to update application level configuration data needed for eNB and en-gNB to interoperate correctly over the X2 interface.

The procedure uses non UE-associated signalling.

5.1.2.2 8.7.2.2 Successful Operation

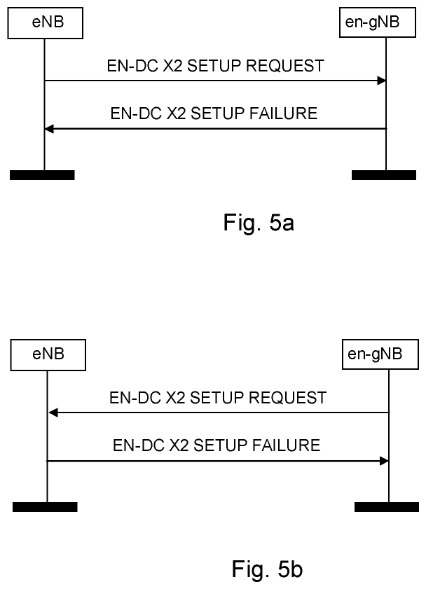

FIG. 6a (corresponding to FIG. 8.7.2.2-1 in 36.423 v15.5.0) depicts: eNB Initiated EN-DC Configuration Update, successful operation. FIG. 6b depicts en-gNB Initiated EN-DC Configuration Update, successful operation (corresponding to FIG. 8.7.2.2-2 in 36.423 v15.5.0).

If case of network sharing with multiple cell ID broadcast with shared X2-C signalling transport, as specified in TS 36.300 [15], the EN-DC CONFIGURATION UPDATE message and the EN-DC CONFIGURATION UPDATE ACKNOWLEDGE message shall include the Interface Instance Indication IE to identify the corresponding interface instance.

eNB Initiated EN-DC Configuration Update:

An eNB initiates the procedure by sending an EN-DC CONFIGURATION UPDATE message to a peer en-gNB.

After successful update of requested information, en-gNB shall reply with the EN-DC CONFIGURATION UPDATE ACKNOWLEDGE message to inform the initiating eNB that the requested update of application data was performed successfully.

If the Cell Assistance Information IE is present, the en-gNB shall use it to generate the List of Served NR Cells IE and include the list in the EN-DC CONFIGURATION UPDATE ACKNOWLEDGE message.

If the EN-DC CONFIGURATION UPDATE REQUEST message contains the Protected E-UTRA Resource Indication IE, the receiving en-gNB may take this into account for cell-level resource coordination with the eNB. The en-gNB shall consider the received Protected E-UTRA Resource Indication IE content valid until reception of a new update of the IE for the same eNB. The protected resource pattern indicated in the Protected E-UTRA Resource Indication IE is not valid in subframes indicated by the Reserved Subframes IE, as well as in the non-control region of the MBSFN subframes i.e. it is valid only in the control region therein. The size of the control region of MBSFN subframes is indicated in the Protected E-UTRA Resource Indication IE.

The eNB may initiate a further EN-DC Configuration Update procedure only after a previous EN-DC Configuration Update procedure has been completed.

If Supplementary Uplink is configured at the en-gNB, the en-gNB shall include in the EN-DC X2 CONFIGURATION UPDATE ACKNOWLEDGE message the SUL Information IE and the Supported SUL band List IE for each cell added in the Served NR Cells To Add IE and in the Served NR Cells To Modify IE.

en-gNB Initiated EN-DC Configuration Update:

An en-gNB initiates the procedure by sending an EN-DC CONFIGURATION UPDATE message to an eNB.

If Supplementary Uplink is configured at the en-gNB, the en-gNB shall include in the EN-DC X2 CONFIGURATION UPDATE message the SUL Information IE and the Supported SUL band List IE for each served cell added in the Served NR Cells To Add IE and in the Served NR Cells To Modify IE.

If the Deactivation Indication IE is contained in the Served NR Cells To Modify IE, it indicates that the concerned NR cell was switched off to lower energy consumption, and is available for activation on request from the eNB, as described in TS 36.300 [15].

After successful update of requested information, eNB shall reply with the EN-DC CONFIGURATION UPDATE ACKNOWLEDGE message to inform the initiating en-gNB that the requested update of application data was performed successfully. In case the eNB receives an EN-DC CONFIGURATION UPDATE without any IE except for Message Type IE it shall reply with EN-DC CONFIGURATION UPDATE ACKNOWLEDGE message without performing any updates to the existing configuration.

Upon reception of an EN-DC CONFIGURATION UPDATE message, eNB shall update the information for en-gNB as follows:

Update of Served NR Cell Information:
If Served NR Cells To Add IE is contained in the EN-DC CONFIGURATION UPDATE message, eNB shall add cell information according to the information in the Served NR Cell Information IE.
If Served NR Cells To Modify IE is contained in the EN-DC CONFIGURATION UPDATE message, eNB shall modify information of cell indicated by Old NR-CGI IE according to the information in the Served NR Cell Information IE.
If Served NR Cells To Delete IE is contained in the EN-DC CONFIGURATION UPDATE message, eNB shall delete information of cell indicated by Old NR-CGI IE.

If the EN-DC CONFIGURATION UPDATE RESPONSE message contains the Protected E-UTRA Resource Indication IE, the receiving en-gNB may take this into account for cell-level resource coordination with the eNB. The en-gNB shall consider the received Protected E-UTRA Resource Indication IE content valid until reception of a new update of the IE for the same eNB.

The en-gNB may initiate a further EN-DC Configuration Update procedure only after a previous EN-DC Configuration Update procedure has been completed.

5.1.2.3 8.7.2.3 Unsuccessful Operation

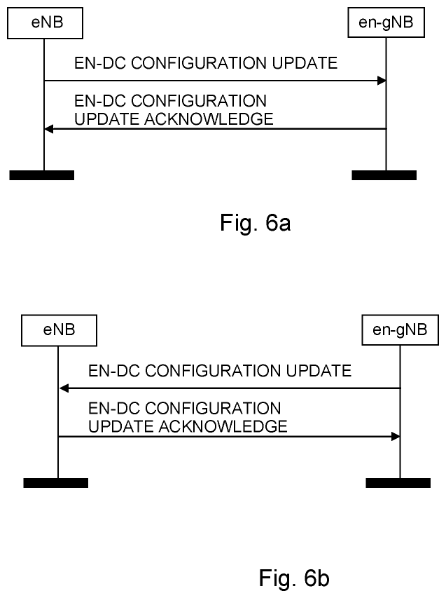

FIG. 7a (corresponding to FIG. 8.7.2.3-1 in 36.423 v15.5.0) depicts eNB Initiated EN-DC Configuration Update, unsuccessful operation. FIG. 7b (corresponding to FIG. 8.7.2.3-2 in 36.423 v15.5.0) depicts en-gNB Initiated EN-DC Configuration Update, unsuccessful operation.

If the candidate receving node can not accept the update it shall respond with an EN-DC CONFIGURATION UPDATE FAILURE message and appropriate cause value.

If the EN-DC CONFIGURATION UPDATE FAILURE message includes the Time To Wait IE the initiating node shall wait at least for the indicated time before reinitiating the EN-DC Configuration Update procedure towards the same peer node. Both nodes shall continue to operate the X2 with their existing configuration data.

If case of network sharing with multiple cell ID broadcast with shared X2-C signalling transport, as specified in TS 36.300 [15], the EN-DC CONFIGURATION UPDATE message and the EN-DC CONFIGURATION UPDATE FAILURE message shall include the Interface Instance Indication IE to identify the corresponding interface instance.

5.1.2.4 8.7.2.4 Abnormal Conditions

If the initiating node after initiating EN-DC Configuration Update procedure receives neither EN-DC CONFIGURATION UPDATE ACKNOWLEDGE message nor EN-DC CONFIGURATION UPDATE FAILURE message, the initiating node may reinitiate the EN-DC Configuration Update procedure towards the same candidate receving node, provided that the content of the EN-DC CONFIGURATION UPDATE message is identical to the content of the previously unacknowledged EN-DC CONFIGURATION UPDATE message.

5.2 Second Change

5.2.1.1 9.1.2.31 EN-DC X2 SETUP REQUEST

This message is sent by an initiating node to a neighbouring node, both nodes able 15 to interact for EN-DC, to transfer the initialization information for a TNL association.

Direction: eNB→en-gNB, en-gNB→eNB.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| CHOICE Initiating | M | | | | | |
| NodeType | | | | | | |
| >eNB | | | | | | |
| >>Global | M | | 9.2.22 | | YES | reject |
| eNB ID | | | | | | |
| >>List | | 1 . . . | | Complete list | YES | reject |
| of Served | | <maxCellineNB> | | of cells served | | |
| E-UTRA Cells | | | | by the eNB | | |
| >>>Served | M | | Served Cell | | — | |
| E-UTRA Cell | | | Information | | | |
| Information | | | 9.2.8 | | | |
| >>>NR | 0 | | 9.2.98 | NR neighbours | YES | ignore |
| Neighbour | | | | | | |
| Information | | | | | | |
| >en-gNB | | | | | | |
| >>Global | M | | 9.2.112 | | YES | reject |
| en-gNB ID | | | | | | |
| >>List | | 1 . . . | | List of cells | YES | reject |
| of Served | | <maxCellinengNB> | | served by the | | |
| NR Cells | | | | engNB. | | |
| >>>Served | M | | 9.2.110 | | — | |
| NR Cell | | | | | | |
| Information | | | | | | |
| >>>NR | O | | 9.2.98 | NR neighbours. | YES | ignore |
| Neighbour | | | | | | |
| Information | | | | | | |
| >>Partial List | O | | ENUMERATED | Value “partial” | YES | ignore |
| Indicator | | | (partial, . . .) | indicates that | | |
| | | | | a partial list of | | |
| | | | | cells is | | |
| | | | | included in the | | |
| | | | | List of Served | | |
| | | | | NR Cells IE | | |
| Maximum Cell | O | | 9.2.xx | Indicates the | YES | ignore |
| List Size | | | | maximum number | | |
| | | | | of cells the | | |
| | | | | sending node | | |
| | | | | can receive in | | |
| | | | | the List of | | |
| | | | | Served NR | | |
| | | | | Cells IE | | |
| Interface | O | | 9.2.143 | | YES | reject |
| Instance | | | | | | |
| Indication | | | | | | |

| Range bound | Explanation |
|---|---|
| maxCellineNB | Maximum no. cells that can be served by an eNB. Value is 256. |
| maxCellinengNB | Maximum no. cells that can be served by an en-gNB. Value is 16384. |

5.2.1.2 9.1.2.32 EN-DC X2 SETUP RESPONSE

This message is sent by a neighbouring node to an initiating node, both nodes able to interact for EN-DC, to transfer the initialization information for a TNL association.

Direction: eNB→en-gNB, en-gNB→eNB.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| CHOICE | M | | | | | |
| Responding | | | | | | |
| NodeType | | | | | | |
| >eNB | | | | | | |
| >>Global | M | | 9.2.22 | | YES | reject |
| eNB ID | | | | | | |
| >>List | | 1 . . . | | Complete list | YES | reject |
| of Served | | <maxCellineNB> | | of cells served | | |
| E-UTRA Cells | | | | by the eNB | | |
| >>>Served | M | | Served Cell | | — | |
| E-UTRA Cell | | | Information | | | |
| Information | | | 9.2.8 | | | |
| >>>NR | 0 | | 9.2.98 | NR neighbours | YES | ignore |
| Neighbour | | | | | | |
| Information | | | | | | |
| >en-gNB | | | | | | |
| >>Global | M | | 9.2.112 | | YES | reject |
| en-gNB ID | | | | | | |
| >>List | | 1 . . . | | List of cells | YES | reject |
| of Served | | <maxCellinengNB> | | served by the | | |
| NR Cells | | | | en-gNB | | |
| >>>Served | M | | 9.2.110 | | — | |
| NR Cell | | | | | | |
| Information | | | | | | |
| >>>NR | O | | 9.2.98 | NR neighbours | YES | ignore |
| Neighbour | | | | | | |
| Information | | | | | | |
| >>Partial List | O | | ENUMERATED | Value “partial” | YES | ignore |
| Indicator | | | (partial, . . .) | indicates that | | |
| | | | | a partial list | | |
| | | | | of cells is | | |
| | | | | included in the | | |
| | | | | List of Served | | |
| | | | | NR Cells IE | | |
| Interface | O | | 9.2.143 | | YES | reject |
| Instance | | | | | | |
| Indication | | | | | | |

| Range bound | Explanation |
|---|---|
| maxCellineNB | Maximum no. cells that can be served by an eNB. Value is 256. |
| maxCellinengNB | Maximum no. cells that can be served by an en-gNB. Value is 16384. |

Note: The Maximum Cell List Size IE is not included in the EN-DC X2 SETUP RESPONSE message above, but this can be a possible expansion of the above message. In a case where the receiving node accept the original setup message it can inform the transmitting node about maximum cell list restrictions in future communication and in such a case it will be beneficial to include the Maximum Cell List Size IE in the EN-DC X2 SETUP RESPONSE.

5.2.1.3 9.1.2.33 EN-DC X2 SETUP FAILURE

This message is sent by the neighbouring node to indicate EN-DC X2 Setup failure.

Direction: eNB→en-gNB, en-gNB→eNB.

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.2.13 | YES | reject |
| Cause | M | 9.2.6 | YES | ignore |
| Criticality | O | 9.2.7 | YES | ignore |
| Diagnostics | | | | |
| Time To Wait | O | 9.2.32 | YES | ignore |
| Interface | O | 9.2.143 | YES | reject |
| Instance | | | | |
| Indication | | | | |
| Message Oversize | O | 9.2.yy | YES | ignore |
| Notification | | | | |

Third Change

9.2.xx Maximum Cell List Size

This IE indicates the maximum size the sending node can handle for a given list.

| | | | | | | |
|---|---|---|---|---|---|---|
| | | | IE type and | Semantics | | Assigned |
| IE/Group Name | Presence | Range | reference | description | Criticality | Criticality |

| | | | |
|---|---|---|---|
| Maximum | M | INTEGER | The IE indicates the |
| Cell List | | (0 . . . 16384) | maximum size the |
| Size | | | sending node can |
| | | | receive for a specific |
| | | | list IE |

5.2.1.4 9.2.yy Message Oversize Notification

This IE indicates that a failure has occurred due to an excessive message size and it may indicate the maximum number of cells that can be received in the List of Served NR Cells IE.

| | | | | | | |
|---|---|---|---|---|---|---|
| | | | IE type and | Semantics | | Assigned |
| IE/Group Name | Presence | Range | reference | description | Criticality | Criticality |

| | | | |
|---|---|---|---|
| Message | M | BOOLEAN | TRUE indicates that |
| Oversize | | | the failure has |
| Failure | | | occurred due to the |
| | | | reception of a |
| | | | message with too |
| | | | large size |
| Maximum | O | 9.2.xx | Indicates the |
| Cell List | | | maximum number |
| Size | | | of cells the sending |
| | | | node can receive in |
| | | | the List of Served |
| | | | NR Cells IE |

As it can be seen from the proposed changes to the standard above, which are based on the EN-DC X2 interface purely for reasons of simplicity (namely equivalent changes apply to the Xn interface as well), three new IEs are introduced.
The Partial List Indicator: This information element is a flag that indicates to the receiving node, i.e. the second network node 330, that the list of cells for which information has been signaled by the sending node is not complete. The flag indicates whether the list of cells for which information has been signaled by the first network node 320 is a partial list of cells or not. Therefore, the receiving node deduces that there might be other cells served by the sending node that might be useful to discover. For example, there might be cells, not indicated by the sending node, that are neighbouring with cells of the receiving node. Therefore those cells are useful to know for e.g. mobility reasons. Consequently, the node receiving a Partial List Indicator might trigger further processes to discover cells that were not listed by the sending nodes. This could happen in a number of ways, some examples are provided below:
Triggering UE measurements to discover new neighbor cells.
Triggering an NG-RAN Node Configuration Update message towards the sending node, including the Cell Assistance Information IE, which indicates a number of NR cells for which receiving further information would be beneficial and/or for which receiving information of neighbor of such cells would be beneficial.
The Maximum Cell List Size: This indicates to the node receiving it the maximum number of entries in the list of served cell information, so to denote very clearly what are e.g. the memory or decoding capabilities of the node sending the IE.
The Message Oversize Notification: This indicates to the receiving node, i.e. the second network node 330, that a failure occurred due to reception of a too large message and it optionally provides a Maximum Cell List Size, as described above. With this information the receiving node deduces that, for future EN-DC X2 or Xn setup attempts towards the same RAN node, limitations in the overall message size and in the number of served cell information to be included in the messages need to be applied if further failures are to be avoided.

It should be noted that although terminology from 3GPP LTE has been used in this disclosure to exemplify the embodiments herein, this should not be seen as limiting the scope of the embodiments herein to only the aforementioned system. Other wireless or wireline systems, including WCDMA, WiMax, UMB, GSM network, any 3GPP cellular network or any cellular network or system, may also benefit from exploiting the ideas covered within this disclosure.

The methods 810, 820 will herein be described from a helicopter perspective as a combined signalling diagram and flowchart showing involved nodes, such as the first network node and the second network node and with reference to FIG. 8a-c.

Action 801. The first and second network nodes 320, 330 are involved in a connection establishment. E.g. establishing an X2 connection or an Xn connection.

Action 811. The first network node 320 transmits to the second network node 330 the message related to the connection establishment between the first and second network nodes 320, 330. The message comprises at least one of: the first indication indicating whether the list of served cells of the first network node 320 comprised in the message is a partial list of cells, i.e. if the list of served cells of the first network node 320 is complete or not complete; the second indication indicating the capacity of the maximum number of cells in a list of served cells of the second network node 330 that the first network node 320 can receive, i.e. the maximum size of the list of served cells of the second network node 330 comprised in a message related to the connection establishment; and a third indication indicating a reason for a failure of the connection establishment. The third indication may e.g. be a flag indicating that the reason is failure due to too large message size.

In some embodiments, the message is at least one of an EN-DC X2 Setup Request message, an EN-DC X2 Setup Response message, an Xn Setup Request message and an Xn Setup Response message. The message may, for example, comprise the first indication, wherein the first indication may be a Partial List Indicator IE.

In other embodiments, the transmitted message is at least one of an EN-DC X2 Setup Failure message and an Xn Setup Failure message. The transmitted message may then comprise the third indication, wherein the third indication is a Message Oversize Notification IE.

In some embodiments, the transmitted message comprises the second indication and wherein the second is a Maximum Cell List Size IE.

Action 821. The second network node 330 receives the message from the first network node 320. As previously described, the message is related to the connection establishment between the first network node 320 and the second network node 330. The message comprises at least one of: the first indication indicating whether a list of served cells of the first network node 320 comprised in the message is a partial list of cells; the second indication indicating a maximum number of cells in a list of served cells of the second network node 330 that the first network node 320 can receive; and the third indication indicating a reason for a failure of the connection establishment.

Action 822. The second network node 330 may then handle connection establishment taking into account the first, second, and/or third indications.

Embodiments herein may be combined with any suitable embodiment described herein.

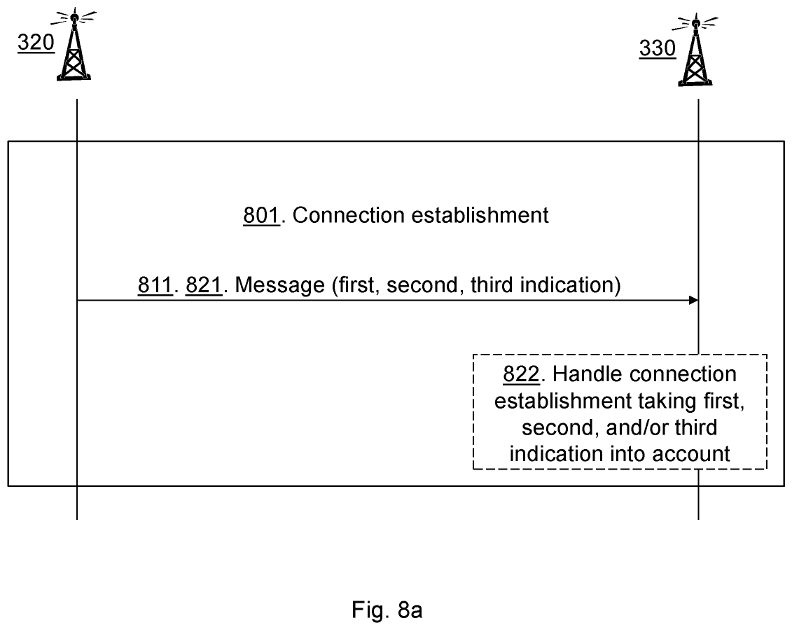

FIG. 9 is a block diagram depicting the first network node 320 in two embodiments configured to operate in the communication network, wherein the communication network 300 comprises the second network node 330. The first network node 320 may be for transmitting indications, e.g. a list of served cells. The first network node 320 may comprise processing circuitry 901 e.g. one or more processors, configured to perform the methods 810 herein.

The first network node 320 may comprise a transmitting unit 902, e.g. a transmitter, transceiver or retrieving module. The first network node 320, the processing circuitry 901, and/or the transmitting unit 902 may be configured to transmit to the second network node 330 the message related to the connection establishment between the first and second network node 320, 330. The message comprises: the first indication that the list of served cells of the first network node comprised in the message is complete or not complete; the second indication of the capacity of the maximum size of the list of served cells of the second network node comprised in a message; and/or the third indication of the reason for the failure of the connection establishment.

The first network node 320 further comprises a memory 903. The memory comprises one or more units to be used to store data on, such as messages, indications, lists of served cells, data, processes to process the data, set of distributions, applications to perform the methods disclosed herein when being executed, and similar.

The methods according to the embodiments described herein for the first network node 320 are respectively implemented by means of e.g. a computer program product 904 or a computer program, comprising instructions, i.e., software code portions, which, when executed on at least one processor, cause the at least one processor to carry out the actions described herein, as performed by the first network node 320. The computer program 904 may be stored on a computer-readable storage medium 905, e.g. a disc, a universal serial bus (USB) stick, or similar. The computer-readable storage medium 905, having stored thereon the computer program product, may comprise the instructions which, when executed on at least one processor, cause the at least one processor to carry out the actions described herein, as performed by the first network node 320. In some embodiments, the computer-readable storage medium may be a non-transitory computer-readable storage medium. The first network node 320 may comprise a communication interface 907 comprising a transceiver, a receiver, a transmitter, and/or one or more antennas.

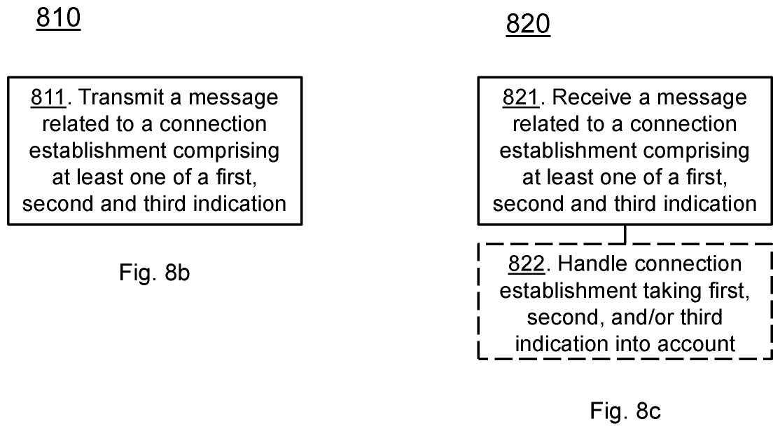

FIG. 10 is a block diagram depicting the second network node 330 in two embodiments configured to operate in the communication network 300, wherein the communication network 300 comprises the first network node 320. The second network node 330 may be for receiving, e.g. receiving the message related to a connection establishment between the first network node 320 and second network node 330. The second network node 330 may comprise processing circuitry 1001 e.g. one or more processors, configured to perform the methods 820 herein.

The second network node 330 may comprise a receiving unit 1002, e.g. a receiver, transceiver or retrieving module. The second network node 330, the processing circuitry 1001, and/or the receiving unit 1002 may be configured to receive from the first network node 320 the message related to the connection establishment between the first and second network node 320, 330. The message comprises: the first indication that a list of served cells of the first network node comprised in the message is complete or not complete; the second indication of the capacity of the maximum size of the list of served cells of the second network node comprised in a message; and/or the third indication of the reason for a failure of the connection establishment.

The second network node 330 may further comprise a handling unit 1003, e.g. a receiver, processor, transmitter or handling module. The second network node 13, the processing circuitry 1001, and/or the handling unit 1003 may be configured to handle connection establishments based on the first, second, and/or third indication.

The second network node 330 further comprises a memory 1004. The memory comprises one or more units to be used to store data on, such as lists of served cells, indications, input parameters, output parameters, insights, data, processes to process the data, set of distributions, applications to perform the methods disclosed herein when being executed, and similar.

The methods according to the embodiments described herein for the second network node 330 are respectively implemented by means of e.g. a computer program product 1005 or a computer program, comprising instructions, i.e., software code portions, which, when executed on at least one processor, cause the at least one processor to carry out the actions described herein, as performed by the second network node 13. The computer program 1005 may be stored on a computer-readable storage medium 1006, e.g. a disc, universal serial bus (USB) stick, or similar. The computer-readable storage medium 1006, having stored thereon the computer program product, may comprise the instructions which, when executed on at least one processor, cause the at least one processor to carry out the actions described herein, as performed by the second network node 330. In some embodiments, the computer-readable storage medium may be a non-transitory computer-readable storage medium. The second network node 330 may comprise a communication interface 1007 comprising a transceiver, a receiver, a transmitter, and/or one or more antennas.

As will be readily understood by those familiar with communications design, that functions means, units, or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of an intermediate network node, for example.

Alternatively, several of the functional elements of the processing circuitry discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

In some embodiments generic terminology “network node”, is used. It may be any kind of network node which may comprise of a core network node, e.g., NOC node, Mobility Managing Entity (MME), Operation and Maintenance (O&M) node, Self-Organizing Network (SON) node, a coordinating node, controlling node, Minimizing Drive Test (MDT) node, etc.), or an external node (e.g., 3rd party node, a node external to the current network), or even a radio network node such as base station, radio base station, base transceiver station, base station controller, network controller, evolved Node B (eNB), Node B, multi-RAT base station, Multi-cell/multicast Coordination Entity (MCE), relay node, access point, radio access point, Remote Radio Unit (RRU) Remote Radio Head (RRH), etc.

The term “radio node” used herein may be used to denote the wireless device or the radio network node.

The term “signalling” used herein may comprise any of: high-layer signalling, e.g., via Radio Resource Control (RRC), lower-layer signalling, e.g., via a physical control channel or a broadcast channel, or a combination thereof. The signalling may be implicit or explicit. The signalling may further be unicast, multicast or broadcast. The signalling may also be directly to another node or via a third node.

The embodiments described herein may apply to any RAT or their evolution, e.g., LTE Frequency Duplex Division (FDD), LTE Time Duplex Division (TDD), LTE with frame structure 3 or unlicensed operation, UTRA, GSM, WiFi, short-range communication RAT, narrow band RAT, RAT for 5G, etc.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

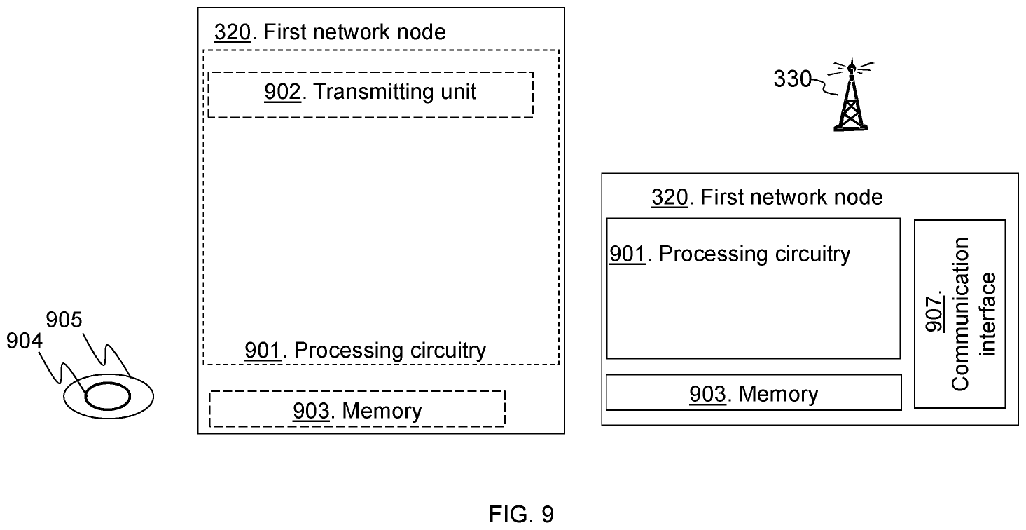

With reference to FIG. 11, in accordance with an embodiment, a communication system includes a telecommunication network 1110 such as the wireless communications network 100, e.g. a NR network, such as a 3GPP-type cellular network, which comprises an access network 1111, such as a radio access network, and a core network 1114. The access network 1111 comprises a plurality of base stations 1112a, 1112b, 1112c, such as the first and second network nodes 320, 330 e.g. access nodes, AP STAs NBs, eNBs, gNBs or other types of wireless access points, each defining a corresponding coverage area 1113a, 1113b, 1113c. Each base station 1112a, 1112b, 1112c is connectable to the core network 1114 over a wired or wireless connection 1115. A first user equipment (UE) e.g. the UE 310 such as a Non-AP STA 1191 located in coverage area 1113c is configured to wirelessly connect to, or be paged by, the corresponding base station 1112c. A second UE 1192 or such as a Non-AP STA in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

The telecommunication network 1110 is itself connected to a host computer 1130, which may be embodied in the hardware and/or software of a standalone server, a cloud-implemented server, a distributed server or as processing resources in a server farm. The host computer 1130 may be under the ownership or control of a service provider, or may be operated by the service provider or on behalf of the service provider. The connections 1121, 1122 between the telecommunication network 1110 and the host computer 1130 may extend directly from the core network 1114 to the host computer 1130 or may go via an optional intermediate network 1120. The intermediate network 1120 may be one of, or a combination of more than one of, a public, private or hosted network; the intermediate network 1120, if any, may be a backbone network or the Internet; in particular, the intermediate network 1120 may comprise two or more sub-networks (not shown).

The communication system of FIG. 11 as a whole enables connectivity between one of the connected UEs 1191, 1192 and the host computer 1130. The connectivity may be described as an over-the-top (OTT) connection 1150. The host computer 1130 and the connected UEs 1191, 1192 are configured to communicate data and/or signaling via the OTT connection 1150, using the access network 1111, the core network 1114, any intermediate network 1120 and possible further infrastructure (not shown) as intermediaries. The OTT connection 1150 may be transparent in the sense that the participating communication devices through which the OTT connection 1150 passes are unaware of routing of uplink and downlink communications. For example, a base station 1112 may not or need not be informed about the past routing of an incoming downlink communication with data originating from a host computer 1130 to be forwarded (e.g., handed over) to a connected UE 1191. Similarly, the base station 1112 need not be aware of the future routing of an outgoing uplink communication originating from the UE 1191 towards the host computer 1130.

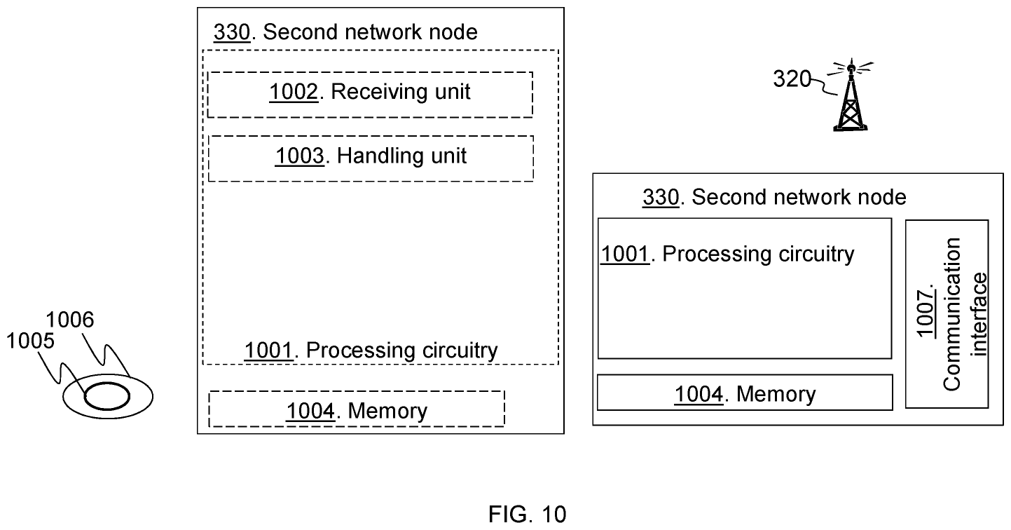

Example implementations, in accordance with an embodiment, of the UE, base station and host computer discussed in the preceding paragraphs will now be described with reference to FIG. 12. In a communication system 1200, a host computer 1210 comprises hardware 1215 including a communication interface 1216 configured to set up and maintain a wired or wireless connection with an interface of a different communication device of the communication system 1200. The host computer 1210 further comprises processing circuitry 1218, which may have storage and/or processing capabilities. In particular, the processing circuitry 1218 may comprise one or more programmable processors, application-specific integrated circuits, field programmable gate arrays or combinations of these (not shown) adapted to execute instructions. The host computer 1210 further comprises software 1211, which is stored in or accessible by the host computer 1210 and executable by the processing circuitry 1218. The software 1211 includes a host application 1212. The host application 1212 may be operable to provide a service to a remote user, such as a UE 1230 connecting via an OTT connection 1250 terminating at the UE 1230 and the host computer 1210. In providing the service to the remote user, the host application 1212 may provide user data which is transmitted using the OTT connection 1250.

The communication system 1200 further includes a base station 1220 provided in a telecommunication system and comprising hardware 1225 enabling it to communicate with the host computer 1210 and with the UE 1230. The hardware 1225 may include a communication interface 1226 for setting up and maintaining a wired or wireless connection with an interface of a different communication device of the communication system 1200, as well as a radio interface 1227 for setting up and maintaining at least a wireless connection 1270 with a UE 1230 located in a coverage area (not shown in FIG. 12) served by the base station 1220. The communication interface 1226 may be configured to facilitate a connection 1260 to the host computer 1210. The connection 1260 may be direct or it may pass through a core network (not shown in FIG. 12) of the telecommunication system and/or through one or more intermediate networks outside the telecommunication system. In the embodiment shown, the hardware 1225 of the base station 1220 further includes processing circuitry 1228, which may comprise one or more programmable processors, application-specific integrated circuits, field programmable gate arrays or combinations of these (not shown) adapted to execute instructions. The base station 1220 further has software 1221 stored internally or accessible via an external connection.

The communication system 1200 further includes the UE 1230 already referred to. Its hardware 1235 may include a radio interface 1237 configured to set up and maintain a wireless connection 1270 with a base station serving a coverage area in which the UE 1230 is currently located. The hardware 1235 of the UE 1230 further includes processing circuitry 1238, which may comprise one or more programmable processors, application-specific integrated circuits, field programmable gate arrays or combinations of these (not shown) adapted to execute instructions. The UE 1230 further comprises software 1231, which is stored in or accessible by the UE 1230 and executable by the processing circuitry 1238. The software 1231 includes a client application 1232. The client application 1232 may be operable to provide a service to a human or non-human user via the UE 1230, with the support of the host computer 1210. In the host computer 1210, an executing host application 1212 may communicate with the executing client application 1232 via the OTT connection 1250 terminating at the UE 1230 and the host computer 1210. In providing the service to the user, the client application 1232 may receive request data from the host application 1212 and provide user data in response to the request data. The OTT connection 1250 may transfer both the request data and the user data. The client application 1232 may interact with the user to generate the user data that it provides.

It is noted that the host computer 1210, base station 1220 and UE 1230 illustrated in FIG. 12 may be identical to the host computer 1130, one of the base stations 1112a, 1112b, 1112c and one of the UEs 1191, 1192 of FIG. 11, respectively. This is to say, the inner workings of these entities may be as shown in FIG. 12 and independently, the surrounding network topology may be that of FIG. 11.

In FIG. 12, the OTT connection 1250 has been drawn abstractly to illustrate the communication between the host computer 1210 and the use equipment 1230 via the base station 1220, without explicit reference to any intermediary devices and the precise routing of messages via these devices. Network infrastructure may determine the routing, which it may be configured to hide from the UE 1230 or from the service provider operating the host computer 1210, or both. While the OTT connection 1250 is active, the network infrastructure may further take decisions by which it dynamically changes the routing (e.g., on the basis of load balancing consideration or reconfiguration of the network).

The wireless connection 1270 between the UE 1230 and the base station 1220 is in accordance with the teachings of the embodiments described throughout this disclosure. One or more of the various embodiments improve the performance of OTT services provided to the UE 1230 using the OTT connection 1250, in which the wireless connection 1270 forms the last segment. More precisely, the teachings of these embodiments may improve the data rate of the RAN and thereby provide benefits such as less user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 1250 between the host computer 1210 and UE 1230, in response to variations in the measurement results. The measurement procedure and/or the network functionality for reconfiguring the OTT connection 1250 may be implemented in the software 1211 of the host computer 1210 or in the software 1231 of the UE 1230, or both. In embodiments, sensors (not shown) may be deployed in or in association with communication devices through which the OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of the OTT connection 1250 may include message format, retransmission settings, preferred routing etc.; the reconfiguring need not affect the base station 1220, and it may be unknown or imperceptible to the base station 1220. Such procedures and functionalities may be known and practiced in the art. In certain embodiments, measurements may involve proprietary UE signaling facilitating the host computer's 1210 measurements of throughput, propagation times, latency and the like. The measurements may be implemented in that the software 1211, 1231 causes messages to be transmitted, in particular empty or ‘dummy’ messages, using the OTT connection 1250 while it monitors propagation times, errors etc.

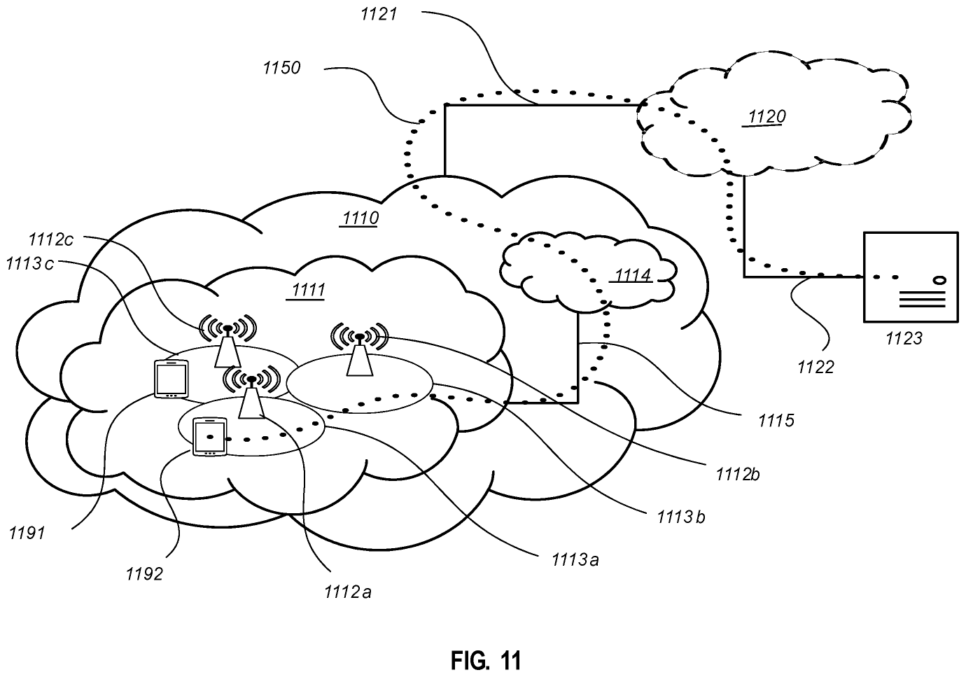

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 13 will be included in this section. In a first action 1310 of the method, the host computer provides user data. In an optional subaction 1311 of the first action 1310, the host computer provides the user data by executing a host application. In a second action 1320, the host computer initiates a transmission carrying the user data to the UE. In an optional third action 1330, the base station transmits to the UE the user data which was carried in the transmission that the host computer initiated, in accordance with the teachings of the embodiments described throughout this disclosure. In an optional fourth action 1340, the UE executes a client application associated with the host application executed by the host computer.

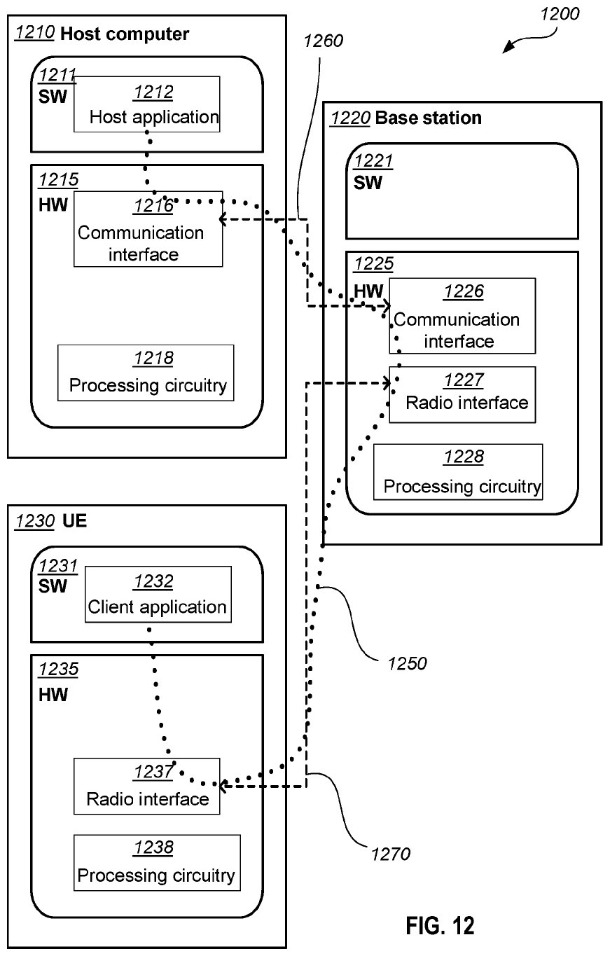

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 14 will be included in this section. In a first action 1410 of the method, the host computer provides user data. In an optional subaction (not shown) the host computer provides the user data by executing a host application. In a second action 1420, the host computer initiates a transmission carrying the user data to the UE. The transmission may pass via the base station, in accordance with the teachings of the embodiments described throughout this disclosure. In an optional third action 1430, the UE receives the user data carried in the transmission.

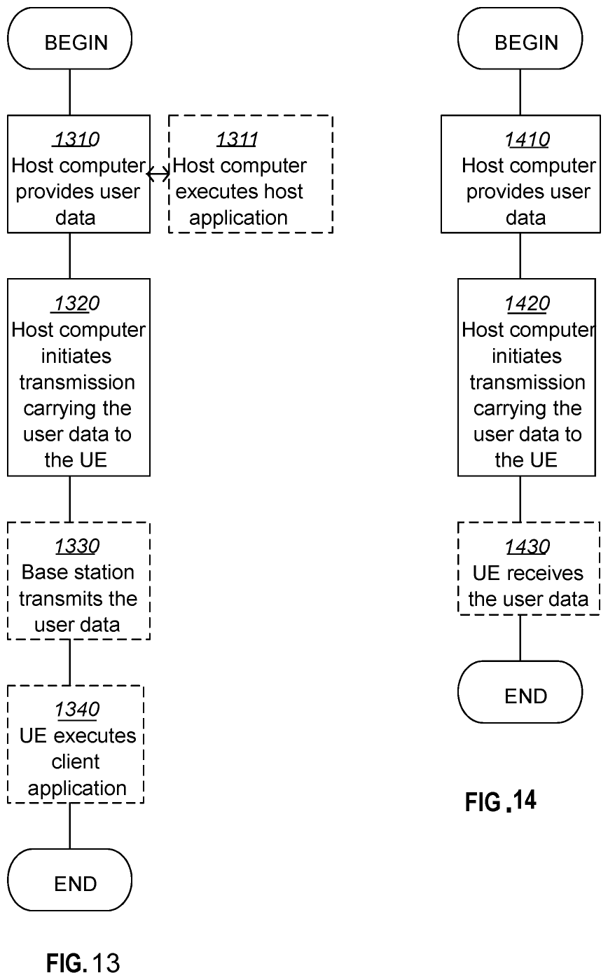

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 15 will be included in this section. In an optional first action 1510 of the method, the UE receives input data provided by the host computer. Additionally or alternatively, in an optional second action 1520, the UE provides user data. In an optional subaction 1521 of the second action 1520, the UE provides the user data by executing a client application. In a further optional subaction 1511 of the first action 1510, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 1530, transmission of the user data to the host computer. In a fourth action 1540 of the method, the host computer receives the user data transmitted from the UE, in accordance with the teachings of the embodiments described throughout this disclosure.

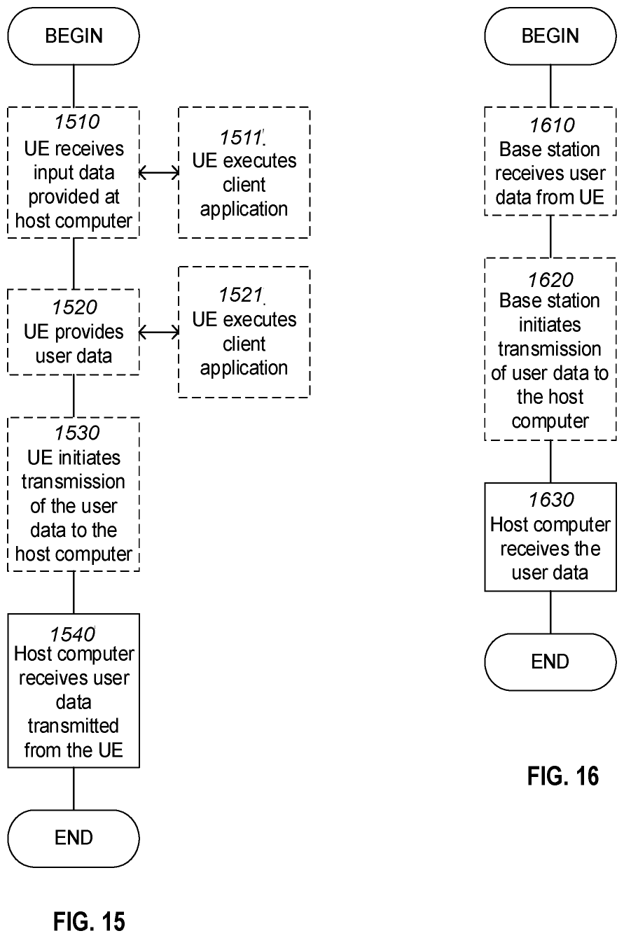

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 16 will be included in this section. In an optional first action 1610 of the method, in accordance with the teachings of the embodiments described throughout this disclosure, the base station receives user data from the UE. In an optional second action 1620, the base station initiates transmission of the received user data to the host computer. In a third action 1630, the host computer receives the user data carried in the transmission initiated by the base station.

When using the word “comprise” or “comprising” it shall be interpreted as non-limiting, i.e. meaning “consist at least of”.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-30. (canceled)

31. A method, performed by a first network node, for handling communication in a wireless communication network, the method comprising the first network node:
transmitting, to a second network node, a message related to a connection establishment between the first network node and the second network node;
wherein the message comprises:
a first indication indicating whether a list of served cells of the first network node comprised in the message is a partial list of cells;
a second indication indicating a maximum number of cells in a list of served cells of the second network node that the first network node can receive; and/or
a third indication indicating a reason for a failure of the connection establishment.

32. The method of claim 31, wherein the transmitted message is an EN-DC X2 Setup Request message, an EN-DC X2 Setup Response message, an Xn Setup Request message, and/or an Xn Setup Response message.

33. The method of claim 32:
wherein the transmitted message comprises the first indication; and
wherein the first indication is a Partial List Indicator Information Element (IE).

34. The method of claim 31, wherein the transmitted message is an EN-DC X2 Setup Failure message and/or an Xn Setup Failure message.

35. The method of claim 34:
wherein the transmitted message comprises the third indication; and
wherein the third indication is a Message Oversize Notification Information Element (IE).

36. The method of claim 31:
wherein the transmitted message comprises the second indication; and
wherein the second indication is a Maximum Cell List Size Information Element (IE).

37. A method, performed by a second network node, for handling communication in a wireless communication network, the method comprises the second network node:
receiving, from a first network node, a message related to a connection establishment between the first network node and the second network node;
wherein the message comprises:
a first indication indicating whether a list of served cells of the first network node comprised in the message is a partial list of cells;
a second indication indicating a maximum number of cells in a list of served cells of the second network node that the first network node can receive; and/or
a third indication indicating a reason for a failure of the connection establishment.

38. The method of claim 37, wherein the method further comprises handling the connection establishment based on the first, second, and/or third indication.

39. The method of claim 37, wherein the received message is an EN-DC X2 Setup Request message, an EN-DC X2 Setup Response message, an Xn Setup Request message, and/or an Xn Setup Response message.

40. The method of claim 39:
wherein the received message comprises the first indication; and
wherein the first indication is a Partial List Indicator Information Element (IE).

41. The method of claim 37, wherein the received message is an EN-DC X2 Setup Failure message and/or an Xn Setup Failure message.

42. The method of claim 41:
wherein the received message comprises the third indication; and
wherein the third indication is a Message Oversize Notification Information Element (IE).

43. The method of claim 37:
wherein the received message comprises the second indication; and
wherein the second is a Maximum Cell List Size Information Element (IE).

44. A first network node for handling communication in a wireless communication network, the first network node comprising:
processing circuitry;
memory containing instructions executable by the processing circuitry whereby the first network node is operative to:
transmit, to a second network node, a message related to a connection establishment between the first network node and the second network node;
wherein the message comprises:
a first indication indicating whether a list of served cells of the first network node comprised in the message is a partial list of cells;
a second indication indicating a maximum number of cells in a list of served cells of the second network node that the first network node can receive; and/or
a third indication indicating a reason for a failure of the connection establishment.

45. The first network node of claim 44, wherein the transmitted message is an EN-DC X2 Setup Request message, an EN-DC X2 Setup Response message, an Xn Setup Request message, and/or an Xn Setup Response message.

46. The first network node of claim 45:
wherein the transmitted message comprises the first indication; and
wherein the first indication is a Partial List Indicator Information Element (IE).

47. The first network node of claim 44, wherein the transmitted message is an EN-DC X2 Setup Failure message and/or an Xn Setup Failure message.

48. The first network node of claim 47:
wherein the transmitted message comprises the third indication; and
wherein the third indication is a Message Oversize Notification Information Element (IE).

49. The first network node of claim 44:
wherein the transmitted message comprises the second indication; and
wherein the second is a Maximum Cell List Size Information Element (IE).

50. The first network node of claim 44, wherein the first network node is an eNB or an gNB.

51. A second network node for handling communication in a wireless communication network, the second network node comprising:
processing circuitry;
memory containing instructions executable by the processing circuitry whereby the second network node is operative to:
receive, from a first network node, a message related to a connection establishment between the first network node and the second network node;
wherein the message comprises:
a first indication indicating whether a list of served cells of the first network node comprised in the message is a partial list of cells;
a second indication indicating a maximum number of cells in a list of served cells of the second network node that the first network node can receive; and/or
a third indication indicating a reason for a failure of the connection establishment.

52. The second network node of claim 51, wherein the instructions are such that the second network node is operative to handle the connection establishment based on the first, second and/or third indication.
